(19) United States
(12) Patent Application Publication
(10) Pub. No.: US 2026/0119260 A1
(43) Pub. Date: Apr. 30, 2026

(54) Implementing Isolated Shared CPU Pools

(71) Applicant: Rakuten Mobile, Inc., Tokyo (JP)

(72) Inventors: Sree Nandan Atur, San Mateo, CA (US); Mruthyunjaya Navali, Boston, MA (US); Manjunath Mageswaran, San Mateo, CA (US)

(21) Appl. No.: 18/930,770

(22) Filed: Oct. 29, 2024

(51) Int. Cl. G06F 9/50

(52) U.S. Cl. CPC G06F 9/5044; G06F 9/5061

(57) ABSTRACT

Isolated shared pools of CPUs are reserved for allocation by a device plugin, such as a system daemon rather than by a Kubelet and the CPUs are hidden from the Kubelet. The device plugin is referenced as a processing device and the Kubelet requests allocation of CPUs from the device plugin. A container runtime interface detects references to the device plugin and binds containers to the reserved CPUs. A mutating webhook may modify requests prior to receipt by the Kubelet to reference the device plugin rather than CPUs.

### BACKGROUND

### Field of the Invention

The present disclosure relates to implementing isolated shared CPU pools.

### Background

The information disclosed in this background section is only for enhancement of understanding of the general background of the disclosure and should not be taken as an acknowledgement or any form of suggestion that this information forms the prior art already known to a person skilled in the art.

Containers are a convenient way to execute application instances in a variety of operating environments. A container is software that packages all dependencies of an application instance so that the application instance executes reliably and quickly in any given computing environment. For example, a container may include executable code, runtime, system tools, system libraries, settings, and the like that enable an application instance to execute on a host either with or without an underlying operating system.

A container may be allocated computing resources by a pod providing a logical host to the container and one or more other containers. In particular, in order to provide a degree of performance, stability, and security, one or more central processing units (CPU) of a host including many CPUs may be allocated to a container.

It would be an advancement in the art to improve the allocation of CPUs to containers.

### SUMMARY OF THE INVENTION

In one aspect, a system includes a computing device including a plurality of processing devices and one or more memory devices operably coupled to the plurality of processing devices. The one or more memory devices store executable code that, when executed by the plurality of processing devices, causes the plurality of processing devices to: reserve a portion of the plurality of processing devices by a device plugin, the portion including at least two processing devices of the plurality of processing devices; receive, by an orchestrator, a request for instantiation of a container including a processor request for an amount of processing devices of the device plugin; request, by the orchestrator, allocation of the amount by the device plugin; instantiate, by a container runtime interface, the container; and bind, by the container runtime interface, the container to execute on any of the portion of the plurality of processing devices.

In another aspect, a method includes reserving, by a computing device including a plurality of processing devices, a portion of the plurality of processing devices by a device plugin, the portion including at least two processing devices of the plurality of processing devices; receiving, by an orchestrator executing on the computing device, a request for instantiation of a container including a processor request for an amount of processing devices of the device plugin; requesting, by the orchestrator, allocation of the amount by the device plugin; instantiating, by a container runtime interface executing on the computing device, the container; and binding, by the container runtime interface, the container to execute on any of the portion of the plurality of processing devices.

In yet another aspect, a non-transitory computer-readable medium stores executable instructions that, when executed by a plurality of processing devices, cause the plurality of processing devices to: reserve a portion of the plurality of processing devices by a device plugin, the portion including at least two processing devices of the plurality of processing devices; receive, by an orchestrator, a request for instantiation of a container including a processor request for an amount of processing devices of the device plugin; request, by the orchestrator, allocation of the amount by the device plugin; instantiate, by a container runtime interface, the container; and bind, by the container runtime interface, the container to execute on any of the portion of the plurality of processing devices.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a network environment in which containers may be deployed in accordance with an embodiment;

FIG. 2 is a schematic block diagram showing components for allocating CPUs in accordance with an embodiment;

FIG. 3 is a process flow diagram of a method for implementing burstable pods using isolated shared pools in accordance with an embodiment;

FIG. 4 is a schematic block diagram of an example computing device suitable for implementing methods in accordance with embodiments of the disclosure.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

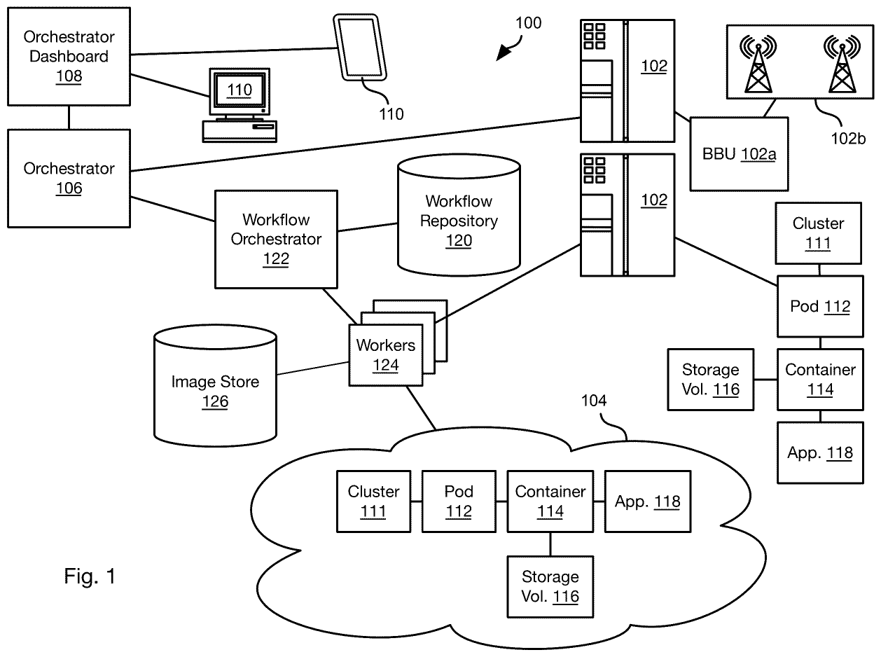

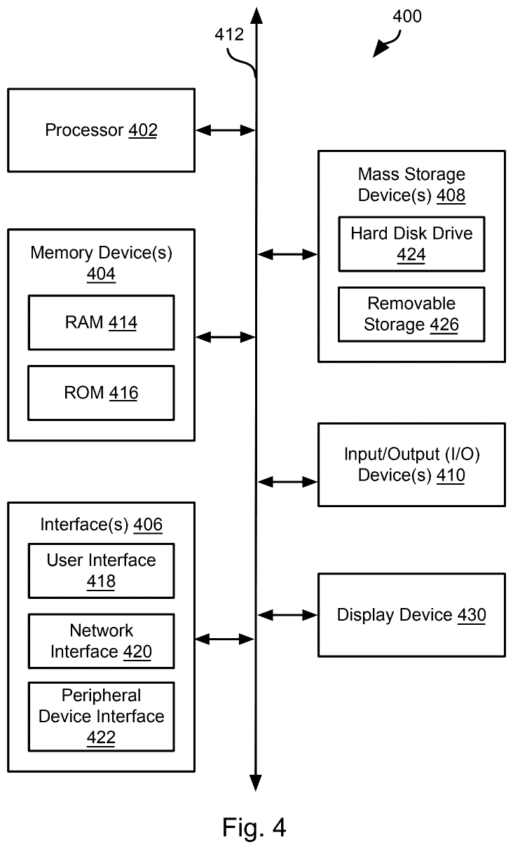

FIG. 1 illustrates an example network environment 100 in which the systems and methods disclosed herein may be used. The components of the network environment 100 may be connected to one another by a network such as a local area network (LAN), wide area network (WAN), the Internet, a backplane of a chassis, or other type of network. The components of the network environment 100 may be connected by wired or wireless network connections. The network environment 100 includes a plurality of servers 102. Each of the servers 102 may include one or more computing devices, such as a computing device having some or all of the attributes of the computing device 400 of FIG. 4.

Computing resources may also be allocated and utilized within a cloud computing platform 104, such as amazon web services (AWS), GOOGLE CLOUD, AZURE, or other cloud computing platform. Cloud computing resources may include purchased physical storage, processor time, memory, and/or networking bandwidth in units designated by the provider by the cloud computing platform.

In some embodiments, some or all of the servers 102 may function as edge servers in a telecommunication network. For example, some or all of the servers 102 may be coupled to baseband units (BBU) 102a that provide translation between radio frequency signals output and received by antennas 102b and digital data transmitted and received by the servers 102. For example, each BBU 102a may perform this translation according to a cellular wireless data protocol (e.g., 4G, 5G, etc.). Servers 102 that function as edge servers may have limited computational resources or may be heavily loaded.

An orchestrator 106 provisions computing resources to application instances 118 of one or more different application executables, such as according to a manifest that defines requirements of computing resources for each application instance. The manifest may define dynamic requirements defining the scaling up or scaling down of a number of application instances 118 and corresponding computing resources in response to usage. The orchestrator 106 may include or cooperate with a utility such as KUBERNETES to perform dynamic scaling up and scaling down the number of application instances 118.

An orchestrator 106 may execute on a computer system that is distinct from the servers 102 and is connected to the servers 102 by a network that requires the use of a destination address for communication, such as using a networking including ethernet protocol, internet protocol (IP), Fibre Channel, or other protocol, including any higher-level protocols built on the previously-mentioned protocols, such as user datagram protocol (UDP), transport control protocol (TCP), or the like.

The orchestrator 106 may cooperate with the servers 102 to initialize and configure the servers 102. For example, each server 102 may cooperate with the orchestrator 106 to obtain a gateway address to use for outbound communication and a source address assigned to the server 102 for use in inbound communication. The server 102 may cooperate with the orchestrator 106 to install an operating system on the server 102.

The orchestrator 106 may be accessible by way of an orchestrator dashboard 108. The orchestrator dashboard 108 may be implemented as a web server or other server-side application that is accessible by way of a browser or client application executing on a user computing device 110, such as a desktop computer, laptop computer, mobile phone, tablet computer, or other computing device.

The orchestrator 106 may cooperate with the servers 102 in order to provision computing resources of the servers 102 and instantiate components of a distributed computing system on the servers 102 and/or on the cloud computing platform 104. For example, the orchestrator 106 may ingest a manifest defining the provisioning of computing resources to, and the instantiation of, components such as a cluster 111, pod 112 (e.g., KUBERNETES pod), container 114 (e.g., DOCKER container), storage volume 116, and an application instance 118. The orchestrator may then allocate computing resources and instantiate the components according to the manifest.

The manifest may define requirements such as network latency requirements, affinity requirements (same node, same chassis, same rack, same data center, same cloud region, etc.), anti-affinity requirements (different node, different chassis, different rack, different data center, different cloud region, etc.), as well as minimum provisioning requirements (number of cores, amount of memory, etc.), performance or quality of service (QoS) requirements, or other constraints. The orchestrator 106 may therefore provision computing resources in order to satisfy or approximately satisfy the requirements of the manifest.

The instantiation of components and the management of the components may be implemented by means of workflows. A workflow is a series of tasks, executables, configuration, parameters, and other computing functions that are predefined and stored in a workflow repository 120. A workflow may be defined to instantiate each type of component (cluster 111, pod 112, container 114, storage volume 116, application instance, etc.), monitor the performance of each type of component, repair each type of component, upgrade each type of component, replace each type of component, copy (snapshot, backup, etc.) and restore from a copy each type of component, and other tasks. Some or all of the tasks performed by a workflow may be implemented using KUBERNETES or other utility for performing some or all of the tasks.

The orchestrator 106 may instruct a workflow orchestrator 122 to perform a task with respect to a component. In response, the workflow orchestrator 122 retrieves the workflow from the workflow repository 120 corresponding to the task (e.g., the type of task (instantiate, monitor, upgrade, replace, copy, restore, etc.) and the type of component. The workflow orchestrator 122 then selects a worker 124 from a worker pool and instructs the worker 124 to implement the workflow with respect to a server 102 or the cloud computing platform 104. The instruction from the orchestrator 106 may specify a particular server 102, cloud region or cloud provider, or other location for performing the workflow. The worker 124, which may be a container, then implements the functions of the workflow with respect to the location instructed by the orchestrator 106. In some implementations, the worker 124 may also perform the tasks of retrieving a workflow from the workflow repository 120 as instructed by the workflow orchestrator 122. The workflow orchestrator 122 and/or the workers 124 may retrieve executable images for instantiating components from an image store 126.

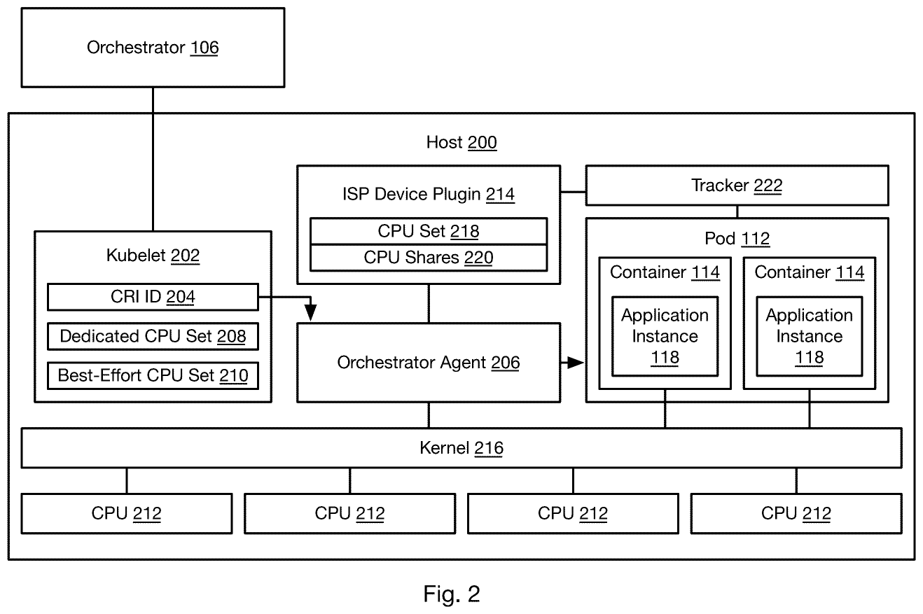

Referring to FIG. 2, a host 200 may be a server 102, a unit of computing resources on the cloud computing platform 104, a virtual machine, or other computing device. A Kubelet 202 may execute on the host 200. The Kubelet 202 may implement a pod 112 on the host 200 and manage containers 114 and corresponding application instances 118 executing on the host 200. The Kubelet 202, and the pod 112 implemented by the Kubelet 202, may function as a logical host for multiple containers 114. The pod 112 may include a set of namespaces, a file system (e.g., built on a storage volume 116), or other data structures that are shared by containers 114 belonging to the pod 112.

The Kubelet 202 may be configured with a container runtime interface (CRI) identifier 204 that refers to an orchestrator agent 206 that is an agent of the orchestrator 106 and may communicate with the orchestrator 106 in order to perform the functions ascribed herein to the orchestrator agent 206. The Kubelet 202 may call the orchestrator agent 206 as a CRI to perform tasks with respect to containers 114 instantiated in the pod 112, such as to instantiate containers 114, suspend containers 114, de-instantiate containers 114, monitor the status of containers 114, monitor usage of computing resources by the containers 114, and other tasks. The orchestrator 106 performs tasks as instructed by the Kubelet 202 and performs additional functions in order to extend the functionality of the pod 112 and containers 114 beyond that provided by conventional KUBERNETES.

The Kubelet 202 may maintain a dedicated CPU set 208 and a best-effort CPU set 210. The sets 208, 210 are used by the Kubelet 202 to determine whether a CPU 212 is available for allocation or not. For example, once the number of CPUs included in the sets 208, 210 is equal to the total number of CPUs 212, then no further CPUs will be allocated by the Kubelet 202. The host 200 includes a plurality of CPUs 212 that may be referenced in either the dedicated CPU set 208, the best-effort CPU set 210, or remain unallocated. The Kubelet 202 may allocate the CPUs to one of the sets 208, 210 by means of the orchestrator agent 206, which may coordinate with the kernel 216 (or other software component) of the host 200 in order to bind CPUs 212 to a particular container 114 or group of containers. As used herein “CPU” may refer to an entire CPU chip including multiple cores, an individual processing core of a multi-core chip, a logical unit of processing defined by the cloud computing platform 104, or other processing device.

The CPUs 212 assigned to the dedicated CPU set 208 are available for use only by the container to which the CPUs 212 are allocated. Accordingly, the CPU set 208 may include entries including a container identifier corresponding to a container 114 and one or more CPU identifiers corresponding to the one or more CPUs 212 allocated to the container 114.

The CPUs 212 assigned to the best-effort CPU set 210 are available for use by any container 114 as well as other processes executing on the host 200, such as the Kubelet 202, orchestrator agent 206, the kernel 216, an operating system, or other processes or services implemented on the host 200. Processing time of the CPUs 212 in the best-effort CPU set may be allocated on a round-robin fashion, based on priorities, or any other criteria known in the art for sharing processing time among a plurality of processes. The best-effort CPU set 210 may include a listing of the identifiers of CPUs 212 assigned to the best-effort CPU set 210.

In KUBERNETES, the Kubelet 202 will process a request for allocating one or more CPUs to be shared by multiple containers 114 by simply adding references to the one or more CPUs to the best-effort CPU set 210. The multiple containers 114 are therefore not guaranteed allocation of the one or more CPUs.

The orchestrator agent 206 may be used to modify behavior of conventional KUBERNETES with respect to burstable pods to overcome deficiencies of KUBERNETES. A burstable pod 112 is one that utilizes a minimum number of CPUs 212, e.g., processor cores of one or more processor chips, but additionally reserves an additional number of CPUs 212 for occasional use up to a maximum number. The orchestrator agent 206 may interface with a kernel 216 executing on the host 200 in order to manage the execution of pods 112 and containers 114 by the CPUs 212.

As discussed in greater detail hereinbelow, the orchestrator agent 206 may operate in conjunction with an isolated shared pool (ISP) device plugin 214. The ISP device plugin 214 may be configured as a system daemon or other process executed by the kernel. In particular, the ISP device plugin 214 may be independent of the Kubelet. The ISP device plugin 214 may advantageously not be instantiated within a pod 112 managed by the Kubelet 202. In some embodiments, the ISP device plugin 214 may execute on CPUs 212 allocated for processing the Kubelet 202, operating system, and other system processes, which may be part of the best effort CPU set 210.

The ISP device plugin 214 may maintain sets of data used by the ISP device plugin 214 to allocate CPUs to shared burstable pods. This data may include a CPU set 218, e.g., the identifiers of a slice of two or more CPUs reserved for management by the ISP device plugin 214 and not available for allocation by the Kubelet 202, e.g., hidden from the Kubelet 202. This data may further include CPU shares 220. The CPU shares 220 may define slices of CPUs and allocation of cores to containers 114. For example, each CPU may be represented by the ISP device plugin 214 as N virtual devices, such as 2, 32, 128, 1024, or some other number. Each virtual device may be allocatable to a container 114 and indicate a fraction of the CPU represented by the virtual device that is available for use by the container 114. The ISP device plugin 214 may therefore track allocations and ensure that containers 114, such as of shared burstable pods, have available resources.

In some embodiments, a burstable pod includes a CPU request and a CPU limit. The CPU request is a minimum number of CPUs to be allocated to the burstable pod and the limit is the maximum CPUs that may be used by the burstable pod. In some embodiments, only the CPU request is used and the limit is the entire slice of CPUs managed by the ISP device plugin 214. Accordingly, in such embodiments, the ISP device plugin 214 will reduce the number of virtual devices available by the CPU request of each burstable pod. Where a CPU limit is considered, the ISP device plugin 214 may allocate virtual devices equal to the CPU limit or some intermediate number of CPUs between the CPU request and the CPU limit.

Using conventional Kubernetes, burstable pods 112 are simply treated as best-effort pods and added to the best-effort CPU set 210. Accordingly, enforcement of quotas, limits, or isolation relative to other processes was not possible. Using the ISP device plugin 214 as described below, an isolated shared pool of processors may be allocated to specific pods 112 and containers 114 in order to provide isolation as well as fine-grained allocation of CPU capacity.

Enforcement of utilization of the CPUs in the CPU set 218 may be implemented using data obtained from a tracker 222 that tracks usage by containers 114 of a pod 112, such as “cAdvisor” for DOCKER containers or other source of utilization statistics. For example, the orchestrator agent 206, ISP device plugin 214, or other component may receive usage statistics from the cAdvisor in order to monitor utilization and enforce quotas.

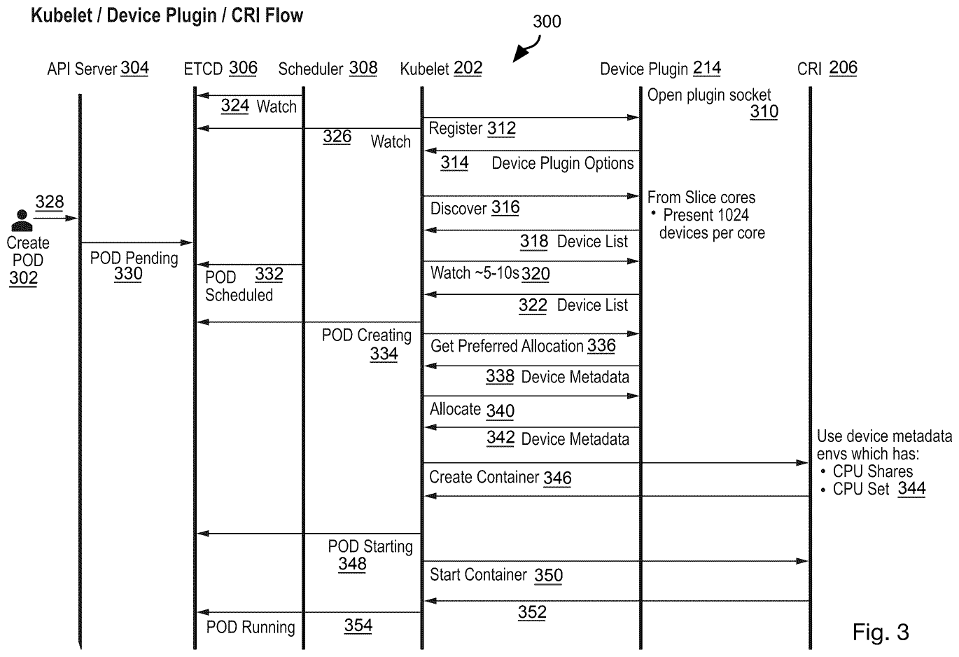

FIG. 3 illustrates a method 300 for utilizing the ISP device plugin 214 to allocate CPUs to shared burstable pods in conjunction with a Kubelet 202.

The method 300 may execute on multiple computing devices. For example, the method 300 may be executed with respect to inputs received from a user 302, such as human user, orchestrator 106, or other entity. A server node may execute an application programming interface (API) server 304 implementing an interface for receiving and executing instructions from the user. The server, or a different server, may execute a key-value store for storing and distributing information describing a state of a KUBERNETES system, such as an ETCD 306 according to the KUBERNETES specification. The server, or a different server, may execute a scheduler 400d for scheduling the performance of tasks, such as tasks performed as part of instantiating pods 112 and containers 114.

The remaining components executing the method 300 may execute on a node executing containers 114 instantiated and managed according to the method 300. For example, the node may execute the ISP device plugin 214 as described above. The node may further execute the Kubelet 202, and orchestrator agent 206 (e.g., acting as a CRI 206).

The method 300 may include configuring 310 the ISP device plugin 214. Step 310 may include reserving CPUs for the ISP device plugin 214 and adding the CPUs to the CPU set 218. Step 310 may further include opening a plugin socket to the ISP device plugin 214 that may be used to access the ISP device plugin 214 as a computing resource, such as in the same manner as a graphics processing unit (GPU), field programmable gate array (FPGA), or other processing device that may be used to extend the processing capacity of a node.

The Kubelet 202 may register 312 with the ISP device plugin 214 in order to discover the capacity of the ISP device plugin 214. The ISP device plugin 214 may return 314 device plugin options in response to the registering of step 312. The Kubelet 202 may use these options to attempt to discover 316 the capabilities of the ISP device plugin 2124. The ISP device plugin 214 may return 318 a device list. For example, step 318 may include the Kubelet 202 returning a listing of the virtual devices available for allocation by the ISP device plugin 214, such as 1024 virtual devices per CPU 212 allocated to the ISP device plugin 214.

The Kubelet 202 may periodically watch 320 (e.g., every 5 to 10 seconds) the ISP device plugin device and receive 322 a current device list in order to maintain awareness of the virtual devices available to be allocated.

The method 300 may include the scheduler 308 watching 324 for changes received by the ETCD 306. The Kubelet 202 may likewise watch 326 for changes received by the ETCD 400c. Steps 324, 326 may continue to be periodically performed such that the scheduler 308 and/or Kubelet 202 will detect changes made to the ETCD 306 as described below.

A user 302 may send 328 a request to create a pod 112 to the server 304. The request may specify a number of CPUs, which may be fractional. The request may include an annotation identify a specific application, type of application, or identify a slice of CPUs on a node. For example, each node may include a system slice of best-effort CPUs that is used for the operating system, Kubernetes, and other system-wide processes; a non-real-time slice for executing shared burstable pods; and a real-time slice including CPUs that are dedicated to a single pod. In some embodiments, the method 300 is performed for only a particular slice, such as the non-real time slice. The CPUs available for shared burstable pods may be isolated from CPUs of other slices but not necessarily from one another, such as by using the “tuna” command in LINUX-based operating systems.

The request from step 328 may be modified, such as by a mutating webhook. For example, the server 304 may add a reference to the ISP device plugin 214 as the requested source of CPUs in response to determining that the request references an application that can use a shared burstable pod, such as a non-real time application. In some embodiments, the server 304 may add a reference to the ISP device plugin 214 if the request from step 328 references a slice of CPUs that is available for shared burstable pods. The mutating webhook may replace references to CPUs (e.g., specific CPUs or a number of CPUs) with a request for a number of CPUs from the ISP device plugin 214.

The server 304 may transmit 330 a pod pending message to the ETCD 306, which may include information from the request from step 328. The scheduler 308 may detect the pod pending message and select a node on which to instantiate the pod 112. For example, supposing the request from step 328 requests a burstable pod having a number of CPUs, the scheduler 308 may identify a node having available CPUs.

The number of available CPUs may be obtained from the ETCD 306. The ETCD 306 be configured with the available CPUs initially available on each node. The ETCD 306 may then reduce the number of available CPUs on a node by the amount of a CPUs in each request to create a pod that is assigned by the scheduler 308 to that node. Accordingly, when a request to create a pod is received by the scheduler 308, the scheduler select a node having sufficient CPUs by evaluating the number of available CPUs on each node as indicated by the ETCD 306. The scheduler 308 may execute a scheduling algorithm to select among nodes with sufficient available CPUs. The scheduler 308 may process request to create burstable pods one at a time in order to avoid exceeding the available virtual devices on the selected node.

The scheduler 308 may transmit 332 a pod scheduled message to the ETCD 306 to schedule creation of the pod 112 on the node selected by the scheduler 308 for the request to create a pod. The Kubelet 202 may detect the pod scheduled message and, in response, may send 334 a pod creating message to the ETCD 306 and perform other actions to invoke instantiation of the pod 112.

For example, the Kubelet 202 may request 336, from the ISP device plugin 214 on the node selected by the scheduler 308, a preferred allocation for the number of CPUs specified in the request from step 328. In response to the request from step 336, the ISP device plugin 214 may return 338 device metadata, which may include identifiers of virtual devices available to be allocated in response to the request from step 336.

The Kubelet 202 may request 340 allocation of the virtual device returned at step 338. In response to the request of step 340, the ISP device plugin 214 may update the CPU shares 220 to indicate that the virtual devices from step 338 have been allocated and return 342 device metadata listing the identifiers of the virtual devices allocated to the Kubelet 202.

The Kubelet may instruct 346 the CRI 206 to create a container 114 that is bound to the virtual devices. The CRI 206, may determine that the virtual devices reference the ISP device plugin 214 and, in response, creates 344 the container 114 and binds the container to the CPUs 212 reserved by or for the ISP device plugin 214. For example, the device metadata returned at step 342 may include environmental variables referencing one or both of the CPU set 218 of the ISP device plugin 214 and the CPU shares 220 allocated to the container 114. The CRI 206 may use the CPU shares 220 to establish quotas for CPU utilization by the container 114. For example, suppose 102 of 1024 shares of a CPU are allocated to the container 114. In response, the CRI 206 may enforce a quota of 102/1024˜=10% of the cycles of one CPU in the CPU set 218 to be used by the container 114. In practice, the container 114 may execute on any of the CPUs of the CPU set 218.

The CRI 206 notifies 346 the Kubelet 202 that the container 114 has been created. In response to the notification of step 346, the Kubelet 202 may transmit a pod starting message to the ETCD 306 and transmit 350 and instruction to the CRI 206 to start execution of the container 114. In response to the instruction from step 350, the CRI 206 commences execution of the container 114 and may notify 352 the Kubelet 202 that the container 114 is executing. In response to the notification of step 352, the Kubelet 202 may send a pod running message to the ETCD 306. Messages sent by the Kubelet 202 to the ETCD 306 may be read by some other component, such as by the orchestrator 106 or other component.

The method 300 may be executed along with allocation of CPUs 212 in the best-effort slice and the real-time slice, such as for requests that do not reference the ISP device plugin 214. For example, the Kubelet may allocate CPUs 212 to either of these slices and bind a container 114 that reference a slice to the CPUs of the slice referenced by a request to instantiate the container 114 as received by the Kubelet. CPUs 212 in the real-time slice may be dedicated to the container 114 to which the CPUs 212 are allocated. Containers 114 executing on the CPUs 212 of the best effort slice may be bound to the CPUs 212 of the best-effort slice and may execute on any CPU 212 of the best effort slice.

FIG. 4 illustrates an embodiment of a computing device 400. As shown in FIG. 4, the device 400 processor 410, a memory 420, a storage component 430, an input component 440, an output component 450, a communication interface 460, and a bus 470.

The processor 410, as used herein, means any type of computational circuit that may comprise hardware elements and software elements. The processor 410 may be embodied as a multi-core processor, a single core processor, or a combination of one or more multi-core processors and/or one or more single core processors, a distributed processing system, or the like. The processor 410 may be a Central Processing Unit (CPU)a graphics processing unit (GPU), an accelerated processing unit (APU), an application-specific integrated circuit (ASIC), or another type of processing component.

Memory 420 includes a non-transitory computer readable medium. Memory 420 includes a random-access memory (RAM), a read only memory (ROM), and/or another type of dynamic or static storage device (e.g., a flash memory, a magnetic memory, and/or an optical memory) that stores information and/or instructions for use by processor 410. The memory 420 comprises machine-readable instructions which are executable by the processor 410. These machine-readable instructions when executed by the processor 410 cause the processor 410 to perform one or more method steps of an embodiment described above.

Storage component 430 stores information and/or software related to the operation and use of the device 400. For example, storage component 430 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 440 is configured to receive information, such as user input. For example, the input component 440 may include, but not be limited to, a touch screen display, a keyboard, a keypad, a mouse, a button, a switch, and/or a microphone. Additionally, or alternatively, the input component 440 may include a sensor for sensing information (e.g., a global positioning system (GPS), an accelerometer, a gyroscope, and/or an actuator).

Output component 450 is configured to provide output information from the device 400. For example, the output component 450 may be, but not limited to, a display, a speaker, instructions to an external device, and/or one or more light-emitting diodes (LEDs).

Communication interface 460 is an interface that provides a communication connection to other devices, such as external devices and internal devices. The connection by the communication interface 460 can be a wired connection, a wireless connection, or a combination of wired and wireless connections, and can be a direct connection or an indirect connection via a communication network that exists between the device 400 and other devices. In other words, the standard of the communication interface 460 is not limited.

The bus 470 acts as an interconnect between the processor 410, the memory 420, the storage component 430, the input component 440, the output component 450, and the communication interface 460 of the device 400. The bus 470 may include a wired interconnection or a wireless interconnection.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400. Further, one or more method steps described in any of the embodiments may be performed utilizing a plurality of devices 400 in communication with one another.

In a first example embodiment, a system includes a computing device including a plurality of processing devices and one or more memory devices operably coupled to the plurality of processing devices, the one or more memory devices storing executable code that, when executed by the plurality of processing devices, causes the plurality of processing devices to: reserve a portion of the plurality of processing devices by a device plugin, the portion including at least two processing devices of the plurality of processing devices; receive, by an orchestrator, a request for instantiation of a container including a processor request for an amount of processing devices of the device plugin; request, by the orchestrator, allocation of the amount by the device plugin; instantiate, by a container runtime interface, the container; and bind, by the container runtime interface, the container to execute on any of the portion of the plurality of processing devices.

In a second example embodiment of the first example embodiment, the device plugin commences execution independent of the orchestrator.

In a third example embodiment of the second example embodiment, the device plugin is a system daemon.

In a fourth example embodiment, the container is a first container, the processor request is a first processor request, and the amount is a first amount; and the executable code, when executed by the plurality of processing devices, further causes the plurality of processing devices to: receive, by the orchestrator, a request for instantiation of a second container including a second processor request for a second amount of processing devices of the device plugin; request, by the orchestrator, allocation of the second amount by the device plugin; instantiate, by the container runtime interface, the second container; and bind, by the container runtime interface, the second container to execute on any of the portion of the plurality of processing devices.

In a fifth example embodiment of the fourth example embodiment, the executable code, when executed by the plurality of processing devices, further causes the plurality of processing devices to: allocate, by the device plugin, the first and second amount of the portion to the first container and the second container.

In a sixth example embodiment of the fourth example embodiment, the first amount and the second amount are fractional.

In a seventh example embodiment of the first example embodiment, the portion is a first portion and the container is a first container; and the executable code, when executed by the plurality of processing devices, further causes the plurality of processing devices to: receive, by the orchestrator, a request for instantiation of a second container including a second processor request for a second amount of processing devices of the plurality of processing devices, the request for instantiation of the second container not referencing the device plugin; allocate, by the orchestrator, the second amount of the plurality of processing devices as dedicated to the second container; instantiate, by the container runtime interface, the second container; and bind, by the container runtime interface the second container to the second amount of the plurality of processing devices.

In an eighth example embodiment of the first example embodiment, the orchestrator is a Kubelet.

In a ninth example embodiment of the first example embodiment, the request references an application type; and the executable code, when executed by the plurality of processing devices, further causes the plurality of processing devices to modify the request to reference the device plugin in response to the application type.

In a tenth example embodiment of the ninth example embodiment, the executable code, when executed by the plurality of processing devices, further causes the plurality of processing devices to modify the request to reference the device plugin in response to the application type using a mutating webhook.

In an eleventh example embodiment, a method includes: reserving, by a computing device including a plurality of processing devices, a portion of the plurality of processing devices by a device plugin, the portion including at least two processing devices of the plurality of processing devices; receiving, by an orchestrator executing on the computing device, a request for instantiation of a container including a processor request for an amount of processing devices of the device plugin; requesting, by the orchestrator, allocation of the amount by the device plugin; instantiating, by a container runtime interface executing on the computing device, the container; and binding, by the container runtime interface, the container to execute on any of the portion of the plurality of processing devices.

In a twelfth example embodiment of the eleventh example embodiment the device plugin commences execution independent of the orchestrator.

In a thirteenth example embodiment of the twelfth example embodiment the device plugin is a system daemon.

In a fourteenth example embodiment of the eleventh example embodiment the container is a first container, the processor request is a first processor request, and the amount is a first amount; and the method further comprises: receiving, by the orchestrator, a request for instantiation of a second container including a second processor request for a second amount of processing devices of the device plugin; requesting, by the orchestrator, allocation of the second amount by the device plugin; instantiating, by the container runtime interface, the second container; and binding, by the container runtime interface, the second container to execute on any of the portion of the plurality of processing devices.

In a fifteenth example embodiment of the fourteenth example embodiment, the method further includes further comprising allocating, by the device plugin, the first and second amount of the portion to the first container and the second container.

In a sixteenth example embodiment of the eleventh example embodiment, wherein the portion is a first portion and the container is a first container; and the method further comprises: receiving, by the orchestrator, a request for instantiation of a second container including a second processor request for a second amount of processing devices of the plurality of processing devices, the request for instantiation of the second container not referencing the device plugin; allocating, by the orchestrator, the second amount of the plurality of processing devices as dedicated to the second container; instantiate, by the container runtime interface, the second container; and binding, by the container runtime interface the second container to the second amount of the plurality of processing devices.

In an seventeenth example embodiment of the eleventh example embodiment, the orchestrator is a Kubelet.

In an eighteenth example embodiment of the eleventh example embodiment the request references an application type; and the method further comprises modifying, by the computing device, the request to reference the device plugin in response to the application type.

In a nineteenth example embodiment of the eighteenth example embodiment, the method further includes modifying the request to reference the device plugin in response to the application type using a mutating webhook.

In a twentieth example embodiment a non-transitory computer-readable medium stores executable instructions that, when executed by a plurality of processing devices, cause the plurality of processing devices to: reserve a portion of the plurality of processing devices by a device plugin, the portion including at least two processing devices of the plurality of processing devices; receive, by an orchestrator, a request for instantiation of a container including a processor request for an amount of processing devices of the device plugin; request, by the orchestrator, allocation of the amount by the device plugin; instantiate, by a container runtime interface, the container; and bind, by the container runtime interface, the container to execute on any of the portion of the plurality of processing devices.

1. A system comprising:
a computing device including a plurality of processing devices and one or more memory devices operably coupled to the plurality of processing devices, the one or more memory devices storing executable code that, when executed by the plurality of processing devices, causes the plurality of processing devices to:
reserve a portion of the plurality of processing devices by a device plugin, the portion including at least two processing devices of the plurality of processing devices;
receive, by an orchestrator, a request for instantiation of a container including a processor request for an amount of processing devices of the device plugin;
request, by the orchestrator, allocation of the amount by the device plugin;
instantiate, by a container runtime interface, the container; and
bind, by the container runtime interface, the container to execute on any of the portion of the plurality of processing devices.

2. The system of claim 1, wherein the device plugin commences execution independent of the orchestrator.

3. The system of claim 2, wherein the device plugin is a system daemon.

4. The system of claim 1, wherein:
the container is a first container, the processor request is a first processor request, and the amount is a first amount; and
the executable code, when executed by the plurality of processing devices, further causes the plurality of processing devices to:
receive, by the orchestrator, a request for instantiation of a second container including a second processor request for a second amount of processing devices of the device plugin;
request, by the orchestrator, allocation of the second amount by the device plugin;
instantiate, by the container runtime interface, the second container; and
bind, by the container runtime interface, the second container to execute on any of the portion of the plurality of processing devices.

5. The system of claim 4, wherein the executable code, when executed by the plurality of processing devices, further causes the plurality of processing devices to:
allocate, by the device plugin, the first and second amount of the portion to the first container and the second container.

6. The system of claim 4, wherein the first amount and the second amount are fractional.

7. The system of claim 1, wherein:
the portion is a first portion and the container is a first container; and
the executable code, when executed by the plurality of processing devices, further causes the plurality of processing devices to:
receive, by the orchestrator, a request for instantiation of a second container including a second processor request for a second amount of processing devices of the plurality of processing devices, the request for instantiation of the second container not referencing the device plugin;
allocate, by the orchestrator, the second amount of the plurality of processing devices as dedicated to the second container;
instantiate, by the container runtime interface, the second container; and
bind, by the container runtime interface the second container to the second amount of the plurality of processing devices.

8. The system of claim 1, wherein the orchestrator is a Kubelet.

9. The system of claim 1, wherein:
the request references an application type; and
the executable code, when executed by the plurality of processing devices, further causes the plurality of processing devices to modify the request to reference the device plugin in response to the application type.

10. The system of claim 9, wherein the executable code, when executed by the plurality of processing devices, further causes the plurality of processing devices to modify the request to reference the device plugin in response to the application type using a mutating webhook.

11. A method comprising:
reserving, by a computing device including a plurality of processing devices, a portion of the plurality of processing devices by a device plugin, the portion including at least two processing devices of the plurality of processing devices;
receiving, by an orchestrator executing on the computing device, a request for instantiation of a container including a processor request for an amount of processing devices of the device plugin;
requesting, by the orchestrator, allocation of the amount by the device plugin;
instantiating, by a container runtime interface executing on the computing device, the container; and
binding, by the container runtime interface, the container to execute on any of the portion of the plurality of processing devices.

12. The method of claim 11, wherein the device plugin commences execution independent of the orchestrator.

13. The method of claim 12, wherein the device plugin is a system daemon.

14. The method of claim 11, wherein:
the container is a first container, the processor request is a first processor request, and the amount is a first amount; and
the method further comprises:
receiving, by the orchestrator, a request for instantiation of a second container including a second processor request for a second amount of processing devices of the device plugin;
requesting, by the orchestrator, allocation of the second amount by the device plugin;
instantiating, by the container runtime interface, the second container; and
binding, by the container runtime interface, the second container to execute on any of the portion of the plurality of processing devices.

15. The method of claim 14, further comprising allocating, by the device plugin, the first and second amount of the portion to the first container and the second container.

16. The method of claim 11, wherein:
the portion is a first portion and the container is a first container; and
the method further comprises:
receiving, by the orchestrator, a request for instantiation of a second container including a second processor request for a second amount of processing devices of the plurality of processing devices, the request for instantiation of the second container not referencing the device plugin;
allocating, by the orchestrator, the second amount of the plurality of processing devices as dedicated to the second container;
instantiate, by the container runtime interface, the second container; and
binding, by the container runtime interface the second container to the second amount of the plurality of processing devices.

17. The method of claim 11, wherein the orchestrator is a Kubelet.

18. The method of claim 11, wherein:
the request references an application type; and
the method further comprises modifying, by the computing device, the request to reference the device plugin in response to the application type.

19. The method of claim 18, further comprising modifying the request to reference the device plugin in response to the application type using a mutating webhook.

20. A non-transitory computer-readable medium storing executable instructions that, when executed by a plurality of processing devices, cause the plurality of processing devices to:
reserve a portion of the plurality of processing devices by a device plugin, the portion including at least two processing devices of the plurality of processing devices;
receive, by an orchestrator, a request for instantiation of a container including a processor request for an amount of processing devices of the device plugin;
request, by the orchestrator, allocation of the amount by the device plugin;
instantiate, by a container runtime interface, the container; and
bind, by the container runtime interface, the container to execute on any of the portion of the plurality of processing devices.
